(19) United States
(12) Patent Application Publication
(10) Pub. No.: US 2009/0091621 A1
(43) Pub. Date: Apr. 9, 2009

(54) DIGITAL CAMERA

(75) Inventors: Hsiang-Yin CHEN, Hsinchu (TW); Chun-Ming CHEN, Kaohsiung City (TW)

Correspondence Address: Workman Nydegger;1000 Eagle Gate Tower, 60 East South Temple, Salt Lake City, UT, 84111, US

(73) Assignee: ALTEK CORPORATION, Hsinchu City (TW)

(21) Appl. No.: 12/016,299

(22) Filed: Jan. 18, 2008

(30) Foreign Application Priority Data
Oct. 3, 2007 (TW) 096137151

(51) Int. Cl. H04N 5/30

(52) U.S. Cl. 348/162; 348/E05.085

(57) ABSTRACT

A digital camera is capable of sensing ultraviolet (UV) intensity. The digital camera includes an UV processing module, a memory, a microprocessor, and a power management module. The UV processing module measures outside UV, so as to generate an UV intensity value and output the UV intensity value to the microprocessor, such that the microprocessor compares the UV intensity value with an UV index (UVI) table stored in the memory to output a comparison value, and the UVI is then displayed on a display. The power management module activates a power management mode according to the comparison value, so as to turn off the power of the camera according to the time-counting about the UV intensity, thereby warning a user of the camera.

### CROSS-REFERENCE TO RELATED APPLICATIONS

This non-provisional application claims priority under 35 U.S.C. § 119(a) on Patent Application No(s). 096137151 filed in Taiwan, R.O.C. on Oct. 3, 2007, the entire contents of which are hereby incorporated by reference.

### BACKGROUND OF THE INVENTION

1. Field of Invention

The present invention relates to an image capturing device. More particularly, the present invention relates to a digital camera and a power management mode thereof.

2. Related Art

Light rays irradiated from sun to the earth can be approximately divided into visible light that can be observed by human eyes, and invisible light that cannot be perceived by human eye. Ultraviolet (UV) is invisible light with a wavelength smaller than that of the visible light, so people cannot directly observe the UV light by naked eyes, but the UV light has close relation with daily life of people. Recently, ozone layer in aerosphere is damaged by people, such that the UV absorption capability of the aerosphere becomes increasingly weak, so the UV amount directly irradiated to the earth surface is gradually increased.

According to research by scientists, excessive UV light may result in the injury of human skin and eyes. For example, after being irradiated by intense UV light, human skin may have flare, suntan, desquamate, and other symptoms. Skin aging may be resulted, or even cytopathy may be induced if things continue this way. In addition, intense UV light may also hurt human eye, damage conjunctiva, cornea, and crystalline lens, which is one of the main reasons of cataract. When people begin to increasingly know the effect of the excessive insolation of the UV light on human body, an UV index (UVI) standard is worked out, i.e., the well-known UVI, and injury insolation levels of the human skin under the irradiation of sunlight with different UVIs are predicted, so as to provide corresponding insolation time limits.

Recently, although it is possible to refer to UVI forecast of each region publicized by weather service unit to know the approximate UVI of the day of each region, it is impossible for the people doing outdoor activity to know the UV amount contained in the environmental light rays at any moment, such that it is impossible for those people to perform relative anti-sunburn measures, and they may be injured by the UV light. Most usually, the situation generates when photographing is performed outside, concentration of photographer and photographee is continuously kept on photographing without considering other matter. Therefore, after once photographing outside, usually the photographer and the photographee are insolated under the sunlight for a long time, if anti-sunburn measures are not performed at any moment, the skin may be injured because of contacting with excessive UV light for a long time. Therefore, during photographing outside, if devices capable of being noticed by the photographer can be used to provide the UV information at the time, and to alarm the photographer properly, the injury of UV light during photographing outside can be prevented.

### SUMMARY OF THE INVENTION

In view of the problem that it is not so easy for the photographer to notice the excessive UV light during photographing outside, the present invention is directed to provide a digital camera, so as to warm the photographer when the UV light is excessive during the photographing outside.

In order to achieve the above objective, the present invention provides a digital camera capable of performing photographing and measuring the UV amount in the environment. The electric power required by the operation of the digital camera is supplied by a power source. The digital camera includes an UV processing module, a memory, a microprocessor, a power management module, and a display, and the power source can be, but not limited to, a cell. The UV processing module measures the outside UV light to generate an UV intensity value. The UV processing module includes a filter lens, a photoelectric sensor, and an analog-to-digital converter. The filter lens is used to filter light rays beyond the UV band from outside light rays, such that UV light is allowed to pass through the filter lens. The photoelectric sensor detects radiant flux of the UV light passing through the filter lens, so as to convert to an UV intensity signal. The analog-to-digital converter is electrically connected to the photoelectric sensor and the microprocessor, so as to receive the UV intensity signal of the photoelectric sensor to generate the UV intensity value and output the UV intensity value to the microprocessor. An UVI table is stored in the memory, and the memory is electrically connected to the microprocessor. The microprocessor receives the UV intensity value output by the UV processing module, and reads the UVI table from the memory, so as to compare the UV intensity value and the UVI table to output a comparison value. The power management module is electrically connected to the microprocessor and the power source, so as to activate a power management mode according to the comparison value output by the microprocessor. The power management module includes a timer and a switch. The timer is electrically connected to the microprocessor, so as to receive the comparison value output by the microprocessor to adjust a counting time. The switch is electrically connected to the timer. When the counting time is reached, the timer generates a turn-off instruction and output the turn-off instruction to the switch, such that the switch turns off the power source of the digital camera. The display is electrically connected to the microprocessor, and the microprocessor compares the UVI table according to the UV intensity value, so as to generate a display instruction, in which the display displays an UVI corresponding to the outside light rays according to the display instruction.

In the present invention, the microprocessor provides anti-sunburn reference for the user of the camera by displaying the UVI of the outside light rays through the display at any moment according to the UV amount in the outside light rays measured by the UV processing module, and controls the power management module to activate the power management mode when the UV is excessive, so as to turn off the power source of the camera according to the intensity of UV in the outside light rays by means of counting, thereby warning the user of the camera.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of functions of a digital camera according to the present invention;

FIG. 2 is an UVI table of the digital camera according to the present invention; and

FIG. 3 is a flow chart of the power management mode executed by the digital camera according to the present invention.

### DETAILED DESCRIPTION OF THE INVENTION

In order to have a further understanding of objective, construction, feature, and function of the present invention, the detailed description is given below with embodiments.

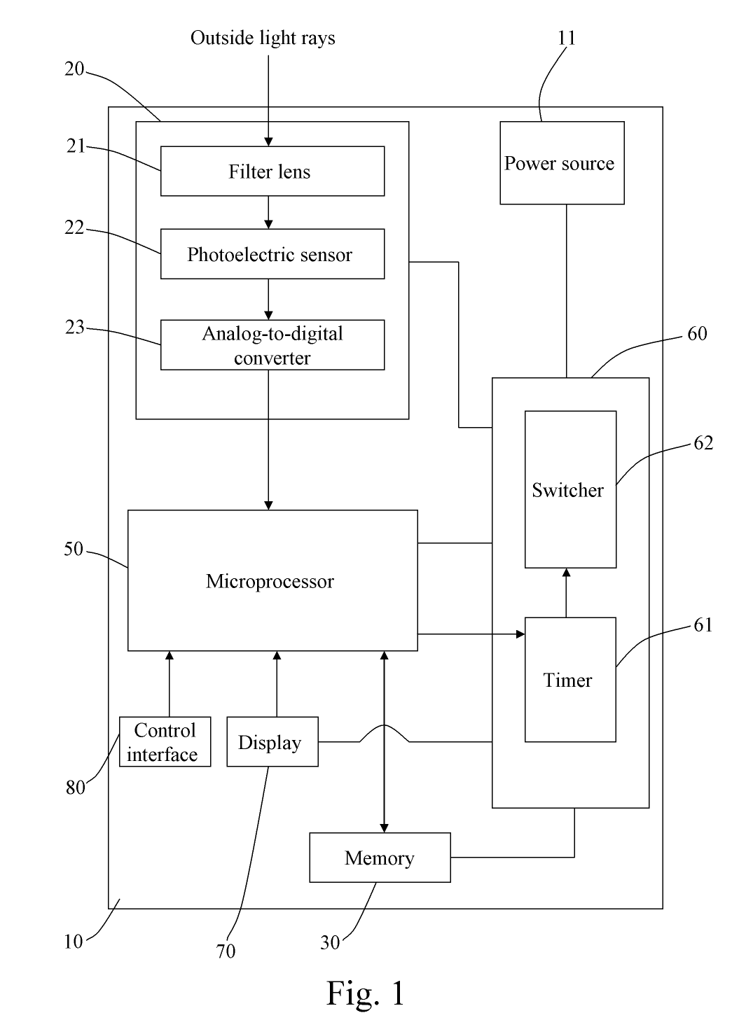

Referring to FIG. 1, a block diagram of functions of a digital camera according to the present invention is shown. A digital camera 10 provided by the present invention can perform image capturing and measure the UV amount in the environment. A power source 11 supplies the required electric power of the digital camera 10. The power source 11 can be, but not limited to, a cell, such as common disposable standard cell, exclusive rechargeable cell, or household power source. Standard electronic parts and optical parts of common digital camera are carried on the digital camera 10, such as lens, photosensitive element, image processor, flash light, and other elements required by image capturing, which belong to the conventional art and will not be described. In addition to the conventional necessary parts, the digital camera 10 of the present invention further includes an UV processing module 20, a memory 30, a microprocessor 50, a power management module 60, a display 70, and a control interface 80.

Referring to FIG. 1, the UV processing module 20 is electrically connected to the microprocessor 50 and the power management module 60, so as to obtain the electric power of the power source 11 through the power management module 60, such that electric signals may be transmitted between the UV processing module 20 and the microprocessor 50. The UV processing module 20 is used to measure the outside UV, so as to generate an UV intensity value and output the UV intensity value to the microprocessor 50. The UV processing module 20 includes a filter lens 21, a photoelectric sensor 22, and an analog-to-digital converter 23. The filter lens 21 is exposed on the surface of a case of the digital camera 10, and receives the outside light rays around the digital camera 10. The filter lens 21 is used to filter light rays beyond UV band from the outside light rays, such that UV light can pass through the filter lens 21, and the light rays beyond UV band cannot pass through the filter lens 21. The photoelectric sensor 22 is used to detect the radiant flux of the UV light passing through the filter lens 21, so as to convert to an UV intensity signal and output the UV intensity signal. The analog-to-digital converter 23 is electrically connected to the photoelectric sensor 22 and the microprocessor 50, so as to receive the UV intensity signal of the photoelectric sensor 22 to generate the UV intensity value corresponding to the UV intensity signal and output the UV intensity value to the microprocessor 50.

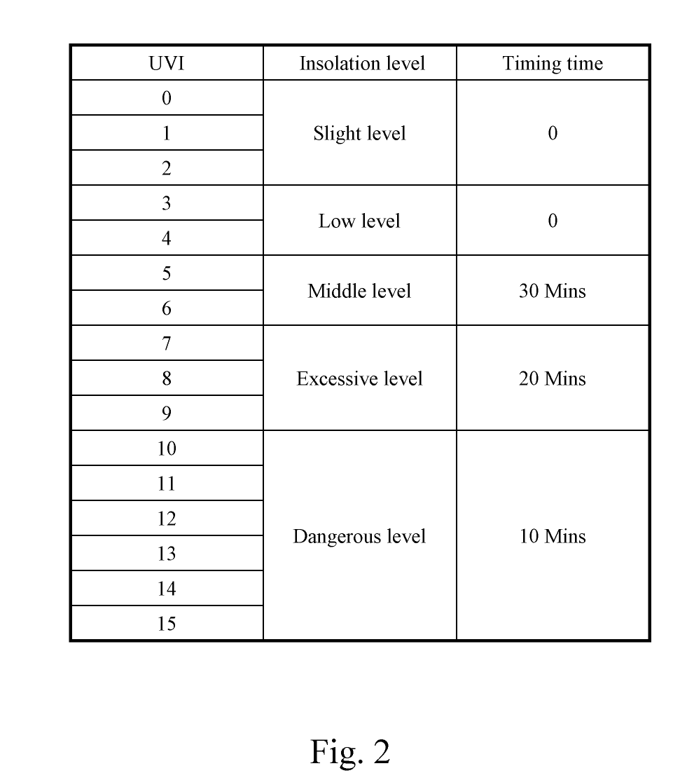

Referring to FIGS. 1 and 2, FIG. 2 is an UVI table provided by the digital camera 10 according to the present invention. The memory 30 is electrically connected to the microprocessor 50 and the power management module 60, so as to obtain the electric power of the power source 11 through the power management module 60, such that the electric signals may be transmitted between the memory 30 and the microprocessor 50. The memory 30 can be an electrically erasable programmable read-only memory (EEPROM) or a flash memory. An ultraviolet index (UVI) table is stored in the memory 30, and the UVI table includes a plurality of UVIs, a plurality of insolation levels corresponding to the UVIs, and a plurality of counting times corresponding to the insolation levels. In the UVI table, the UVIs can be classified into 16 levels from 0 to 15 according to the intensity, and the insolation levels can be classified into 5 levels according to the UVIs, namely, slight level, low level, middle level, excessive level, and dangerous level. According to the insolation time when the human skin may be injured under the light rays with various UVIs, the insolation levels correspond to different counting times respectively. The counting time corresponding to the slight level and the low level is 0, the counting times corresponding to the middle level, the excessive level, and the dangerous level are respectively 30 min, 20 min, and 10 min.

The microprocessor 50 is electrically connected to the UV processing module 20, the memory 30, the power management module 60, the display 70, and the control interface 80, so as to obtain the electric power of the power source 11 through the power management module 60, such that the electric signals may be respectively transmitted between the UV processing module 20, the memory 30, the power management module 60, the display 70, the control interface 80, and the microprocessor 50. The microprocessor 50 receives the UV intensity value output by the UV processing module 20, and reads the UVI table from the memory 30. The microprocessor 50 is used to compare the UV intensity value with the UVI table, so as to determine which UVI level the UV intensity of the outside light rays belongs, and output a display instruction corresponding to the UVI and a comparison value corresponding to each counting time.

The power management module 60 is electrically connected to the UV processing module 20, the memory 30, the microprocessor 50, the display 70, and the power 11, so as to respectively input the electric power of the power source 11 to the UV processing module 20, the memory 30, the microprocessor 50, and the display 70 to supply power. The power management module 60 is used to activate a power management mode according to the comparison value output by the microprocessor 50. The power management module 60 includes a timer 61 and a switch 62. The timer 61 is electrically connected to the microprocessor 50 for receiving the electric signal output by the microprocessor 50, and is powered by the power source 11. The timer 61 receives the comparison value output by the microprocessor 50, so as to adjust the counting time according to the comparison value and perform the counting. When the counting time corresponding to the comparison value is 0, the timer 61 does not perform the counting, and when the counting time corresponding to the comparison value is greater than 0, the timer 61 begins to perform the counting. The switch 62 is electrically connected to the timer 61, so as to receive the electric signal output by the timer 61. The switch 62 is used to turn off the power management module 60 and the power source 11, such that the electric power of the power source 11 cannot be output to the UV processing module 20, the memory 30, the microprocessor 50, and the display 70. When the timer 61 reaches the counting time, the timer 61 generates a turn-off instruction and output the turn-off instruction to the switch 62, such that the switch 62 turns off the power source 11 of the digital camera 10.

The display 70 can be, but not limited to, liquid crystal display. The display 70 is electrically connected to the microprocessor 50 and the power management module 60, so as to obtain the electric power of the power source 11 through the power management module 60, such that the electric signals may be transmitted between the microprocessor 50 and the display 70. The display 70 receives the display instruction output by the microprocessor 50, so as to display an UVI corresponding to the outside light rays. The control interface 80 is electrically connected to the microprocessor 50, such that the electric signals may be transmitted between the control interface 80 and the microprocessor 50, in which the control interface 80 can be, but not limited to, a press button or a touch control panel embedded in the display 70. The control interface 80 operated by a user to generate a trigger signal and output the trigger signal to the microprocessor 50, such that the microprocessor 50 controls the switch 62 of the power management module 60 to turn off the UV processing module 20 and the power source 11, and thus the electric power of the power source 11 cannot be input into the UV processing module 20.

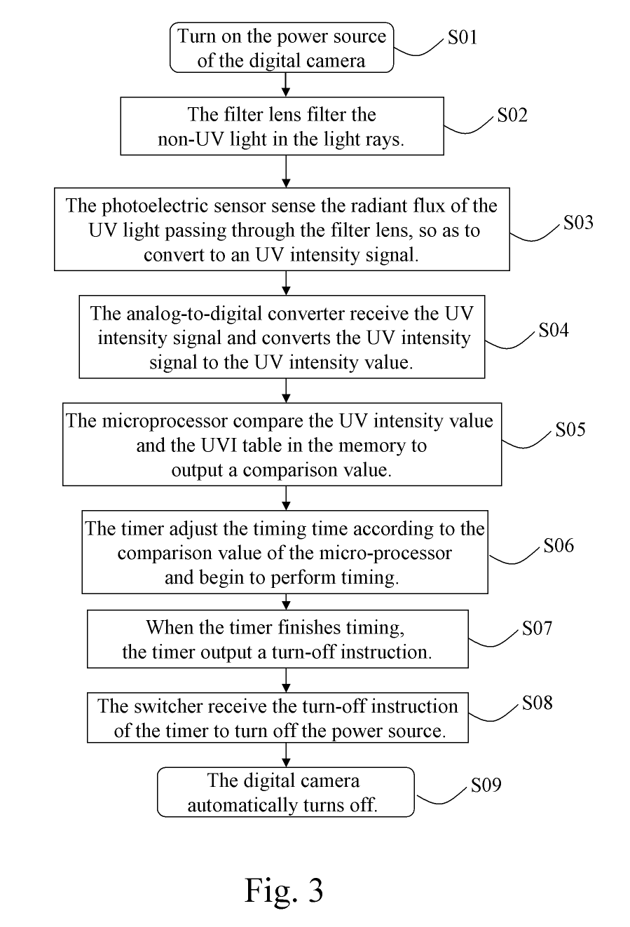

As shown in FIGS. 1, 2, and 3, FIG. 3 is a flow chart of the power management mode executed by the digital camera 10 according the present invention. Firstly, the user of the camera turns on the power source 11 (S01), such that the electric power is supplied to each element of the digital camera 10. At the same time, the filter lens 21 filters the non-UV light from the outside light rays (S02), and allows the UV light to pass through. Next, the photoelectric sensor 22 senses the radiant flux of the UV light passing through the filter lens 21, so as to convert to an UV intensity signal (S03). Then, the analog-to-digital converter 23 receives the UV intensity signal and converts the UV intensity signal to the UV intensity value (S04). Next, the microprocessor compares the UV intensity value and the UVI table to output a comparison value (S05), and the timer 61 adjusts the counting time according to the comparison value and begins to perform counting (S06). Finally, when the timer 61 finishes counting, the timer 61 outputs a turn-off instruction (S07), and after the switch 62 receives the turn-off instruction, the power source 11 is turned off (S08). The digital camera 10 automatically turns off.

In the digital camera 10 of the present invention, the microprocessor 50 provides anti-sunburn reference for the user of the camera by displaying the UVI of the outside light rays through the display 70 at any moment according to the UV amount in the outside light rays measured by the UV processing module 20, and controls the power management module 60 to activate the power management mode when the UV is excessive, so as to turn off the power source 11 of the camera according to the intensity of UV in the outside light rays by means of counting, thereby warning the user of the camera.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital camera, powered by a power source, comprising:
an ultraviolet (UV) processing module, for measuring outside UV to generate an UV intensity value;
a memory, for storing an UV index (UVI) table;
a microprocessor, for receiving the UV intensity value and comparing the UV intensity value with the UVI table to output a comparison value; and
a power management module, electrically connected to the microprocessor and the power source, for activating a power management mode according to the comparison value.

2. The digital camera as claimed in claim 1, wherein the UV processing module comprises:
a filter lens, for filtering light rays beyond UV band in outside light rays, and allowing UV light to pass through the filter lens;
a photoelectric sensor, for detecting radiant flux of the UV light passing through the filter lens, so as to convert to an UV intensity signal; and
an analog-to-digital converter, electrically connected to the photoelectric sensor and the microprocessor, for receiving the UV intensity signal to generate the UV intensity value and output the UV intensity value to the microprocessor.

3. The digital camera as claimed in claim 1, further comprising a display, electrically connected to the microprocessor, wherein the microprocessor compares the UVI table according to the UV intensity value to generate a display instruction, and the display displays an UVI according to the display instruction.

4. The digital camera as claimed in claim 1, wherein the power management module comprises:
a timer, for receiving the comparison value output by the microprocessor, so as to adjust a counting time according to the comparison value and output a turn-off instruction; and
a switch, for receiving the turn-off instruction output by the timer, so as to turn off the power source.

5. The digital camera as claimed in claim 4, further comprising a control interface for generating a trigger signal and outputting the trigger signal to the microprocessor, such that the microprocessor controls the switch to turn off the UV processing module and the power source.

6. The digital camera as claimed in claim 4, wherein the UVI table comprises a plurality of UVIs, a plurality of insolation levels, and a plurality of the counting times corresponding to one another.

7. The digital camera as claimed in claim 1, wherein the memory is an electrically erasable programmable read-only memory (EEPROM).

8. The digital camera as claimed in claim 1, wherein the memory is a flash memory.
